(19) United States
(12) Patent Application Publication
(10) Pub. No.: US 2026/0054236 A1
(43) Pub. Date: Feb. 26, 2026

(54) POWDER HOMOGENIZING DEVICE AND METHOD FOR HOMOGENIZING POWDER

(71) Applicant: Jeff HSIEH, New Taipei (TW)

(72) Inventor: Jeff HSIEH, New Taipei (TW)

(21) Appl. No.: 19/302,674

(22) Filed: Aug. 18, 2025

(30) Foreign Application Priority Data
Aug. 22, 2024 (TW) 113131564

(51) Int. Cl. B01F 33/501; A47J 31/44; B01F 23/60; B01F 27/112; B01F 35/31; B01F 35/32; B01F 35/53; B01F 101/00; B01F 101/14

(52) U.S. Cl. CPC B01F 33/5011; A47J 31/446; B01F 23/60; B01F 27/112; B01F 35/31; B01F 35/32021; B01F 35/5312; B01F 2101/14; B01F 2101/1805

(57) ABSTRACT

A powder homogenizing device is provided. The powder homogenizing device comprises a cup portion having an opening therein, a flange portion extending radially and outwardly from a circumferential edge of the opening of the cup portion, and a coupling portion extending from an outer edge of the flange portion in a direction away from the cup portion, wherein the coupling portion is configured to be adapted to couple to a handle for brewing coffee, and wherein, when the coupling portion of the powder homogenizing device is coupled to the handle, the flange portion of the powder homogenizing device abuts a top edge of a basket of the handle, such that the cup portion of the powder homogenizing device and the basket of the handle collectively form a chamber for containing powder. The subject application further discloses a method for homogenizing powder by using the aforementioned device.

### TECHNICAL FIELD

The present disclosure relates to a powder homogenizing device, and in particular, to a powder homogenizing device that is attached to a handle used for brewing coffee.

### BACKGROUND

When brewing espresso, a user provides a predetermined amount of coffee powder. This predetermined amount of coffee powder is placed into a coffee basket and compacted. The user then uses a handle to secure the coffee basket to the coffee brewing machine for brewing.

The coffee powder used for brewing, made from ground coffee beans, typically exhibits a wide variety of particle sizes, of which smaller particles tend to agglomerate and/or become lodged in the voids formed by the stacking of larger particles, obstructing the flow of fluid intended for brewing. This blockage prevents the fluid from passing evenly through the predetermined amount of coffee powder, thereby affecting the flavor of the coffee.

Please refer to FIGS. 1 to 6, which show a coffee machine 10 and/or a handle 100 from different views. The coffee machine 10 has a connection port 12, which has a connection structure 14 configured to couple to the handle 100. The handle 100 includes a grip 102, a rod portion 104, an outer ring portion 106, a diverter 114, a lower surface 107, a basket portion 112, and a connection portion 108. The connection portion 108 of the handle 100 includes a rotational snap-fit structure corresponding to the connection structure 14 of the coffee machine 10; specifically, the connection structure 14 of the coffee machine 10 consists of a tab that extends inward from the bottom edge of the connection port 12, shaped to engage with the connection portion 108 of the handle 100, allowing the connection portion 108 to engage with the connection structure 14 after being rotated from a predetermined direction. The basket portion 112 may be an individual coffee basket that can be separated from the handle 100 (as shown in the drawings), or it may be integrally formed with the handle 100 as a part of the handle 100.

At least a portion of a lower surface 109 of the connection portion 108 of the handle 100 has a sloped plane, and at least a portion of an upper surface of the connection structure 14 of the coffee machine 10 also has a corresponding sloped plane. When the user grips the handle 100 by its grip 102 and rotates the handle 100, by the cooperation of the two sloped planes, the handle 100 is raised and secured to the coffee machine 10. The connection port 12 of the coffee machine 10 may further include a gasket, and the handle 100 has a flange 110. The upper edge of the basket portion 112 is placed on the flange 110, and when the handle 100 is secured to the coffee machine 10, the upper edge of the basket portion 112 is positioned between the flange 110 of the handle 100 and the gasket of the connection port 12 of the coffee machine 10. As the handle 100 is screwed into the coffee machine 10, the upper edge of the basket portion 112 is clamped and secured in place.

As shown in FIG. 6, when brewing coffee, the first step is to place a predetermined weight of the coffee powder into a basket portion 112 of the handle 100 (see the basket 112 depicted in FIGS. 1, 4, and 5), and then rotate the handle 100 into a coffee machine 10 to secure the same. The bottom of the basket portion 112 of the handle 100 has multiple holes with a diameter of approximately 200-400 μm. A fluid line 16 of the coffee machine 10 will deliver the fluid for brewing to the basket portion 112. After the fluid dissolves and disperses the flavor compounds of the coffee powder in the basket portion 112, it flows through the holes at the bottom of the basket portion 112 and exits through the opening 116 located at the center of the lower surface 107 of the handle 100 (see FIG. 5). Depending on need, a diverter 114 can be used to channel the brewed coffee from the opening on the lower surface 107 of the handle 100. Additionally, the handle 100 may not have the lower surface 107, opening 116, or diverter 114, allowing the fluid to flow directly out of the powder cup 112, wherein the bottom of the basket portion 112 may be curved, and the fluid flowing through the holes at the bottom will converge at the lower edge of the curved portion before flowing down.

FIG. 7 is a magnified photo of coffee powder P under a microscope. As shown, the coffee particle P2, which has a larger particle size, is approximately 7 times larger in diameter than the smaller coffee particle P1. When coffee powder P is packed into the basket portion 112, the coffee particles P1 agglomerate and/or become lodged in the voids formed by the stacking of larger coffee powder P2. This obstruction hinders the flow of the brewing fluid, preventing it from passing evenly through the predetermined weight of coffee powder P and fully dissolving the flavor compounds, thereby affecting the flavor of the coffee.

In response, a new practice is to use a homogenizer to evenly homogenize coffee powder P before placement in the basket portion 112. FIGS. 8 and 9 show a known homogenizer 20, which consists of a container body 24 and a lid 22. The user places the coffee powder P inside the internal space 26 of the container body 24 of the homogenizer 20, then seals the internal space 26 with the lid 22. Next, the user grips the homogenizer 20 and shakes it to ensure that the coffee powder P inside is evenly homogenized. After that, the homogenized coffee powder P is poured into the basket portion 112.

It should be noted that the homogenizer 20 and operation thereof have certain drawbacks. First, to prevent the container body 24 and lid 22 from separating during shaking, the user must grip both the container 24 and the lid 22 tightly to maintain a seal therebetween. Additionally, to evenly homogenize the powder, the user must apply substantial force, using their entire wrist and arm to vigorously shake the homogenizer 20, making the overall operation labor-intensive. Furthermore, after the homogenization is complete, powder uniformity may be disrupted when pouring the powder into the basket portion due to the effects of gravity.

### SUMMARY OF INVENTION

The invention provides a device and method for powder homogenization, allowing easy and accurate loading of a desired amount of coffee powder into a basket portion with homogenized distribution. More specifically, after loading the desired amount of coffee powder into the basket portion, users can attach the device provided to the basket portion and shake the device as well as the powder inside the basket portion to homogenize the powder.

The subject application provides a powder homogenizing device, comprising a cup portion having an opening therein, a flange portion extending radially and outwardly from a circumferential edge of the opening of the cup portion, and a coupling portion extending from an outer edge of the flange portion away from the cup portion, wherein the coupling portion has a latching structure thereon, the latching structure configured to connect with a connection portion of a handle for brewing coffee, allowing the coupling portion to couple to the connection portion of the handle, and wherein, when the coupling portion of the powder homogenizing device is coupled to the handle, the flange portion of the powder homogenizing device abuts a top edge of a basket portion of the handle, such that the cup portion of the powder homogenizing device and the basket portion of the handle collectively form a chamber for containing powder.

Further, the subject application provides a method for homogenizing powder, the method comprising providing a handle for brewing coffee, providing the aforementioned powder homogenizing device, placing powder into a basket portion of the handle or the powder homogenizing device, coupling the powder homogenization device to the handle, and shaking the handle.

The technical features of the disclosure are detailed here, providing a better understanding of the following detailed description. Other technical features of the claimed inventions of the subject application are further recited. One of ordinary skill will appreciate that the concepts and specific embodiments disclosed can modify or design other structures or methods to achieve the objectives disclosed herein, and that such equivalent constructions cannot deviate from the spirit and scope of this disclosure as defined by the claims attached.

### BRIEF DESCRIPTION OF THE DRAWINGS

The following embodiments and accompanying drawings are provided for a better understanding of the disclosure. It should be noted that, for clarity, various components may not be drawn to scale. In fact, the size/scale of the various components can be arbitrarily enlarged or reduced.

FIGS. 1-3 are schematic perspective views of a known coffee machine and handle for brewing coffee.

FIGS. 4 and 5 are schematic exploded perspective views of a known handle for brewing coffee.

FIG. 6 is a schematic side view of a known coffee machine and handle for brewing coffee.

FIG. 7 is a magnified photo of coffee powder P under a microscope.

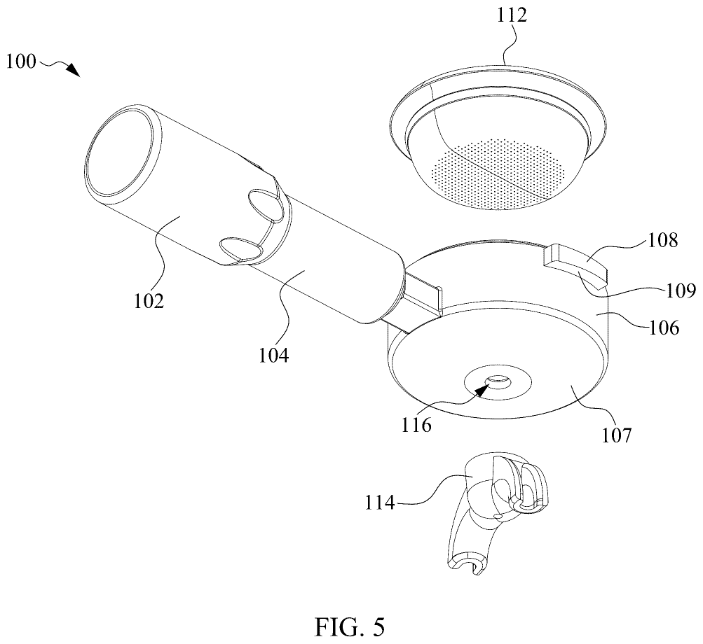

FIG. 8 is a schematic side view of a known homogenizer for coffee powder.

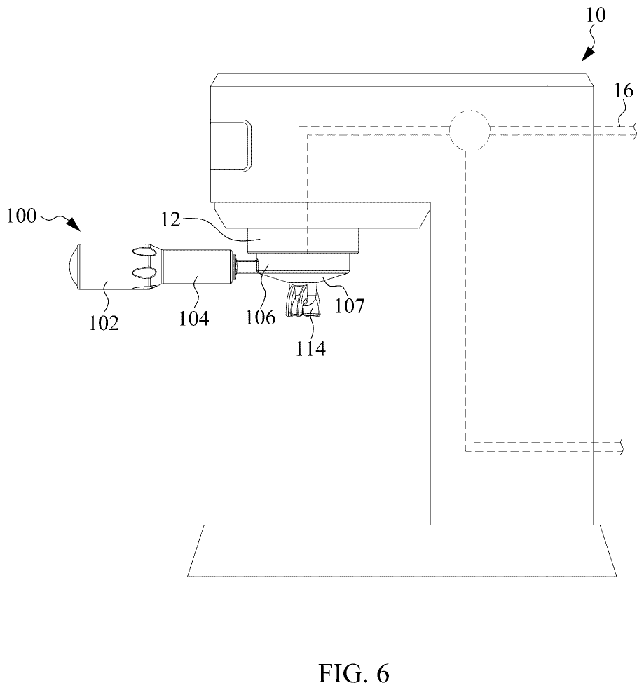

FIG. 9 is a schematic perspective view showing the shaking operation of the known homogenizer shown in FIG. 8.

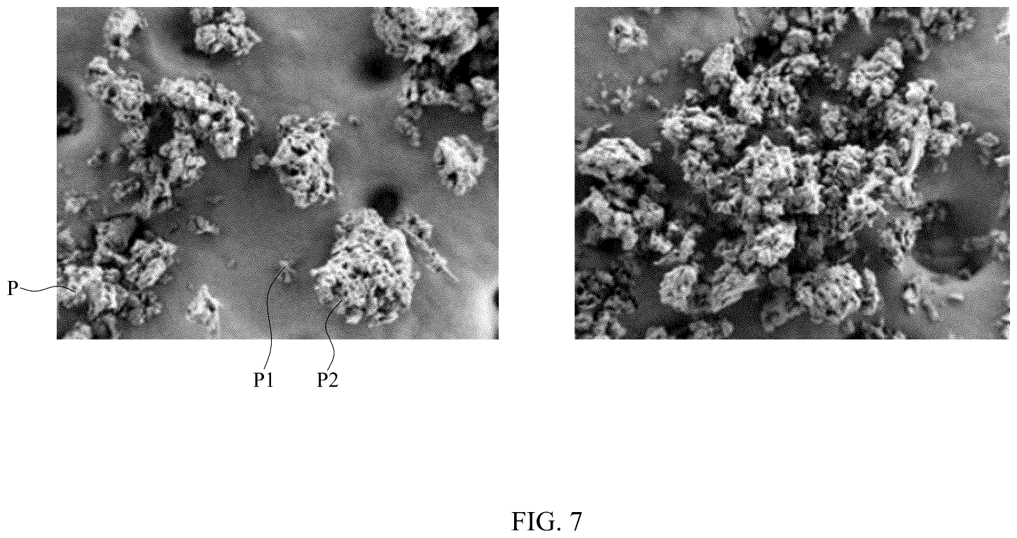

FIG. 10 is a schematic perspective view of a powder homogenizing device, prior to attachment to the handle.

FIG. 11 is a schematic perspective view of a powder homogenizing device including vertical stoppers, prior to attachment to the handle.

FIG. 12 is a schematic perspective view showing a powder homogenizing device including horizontal stoppers, prior to attachment to the handle.

FIG. 13 is a schematic perspective view of a powder homogenizing device, following attachment to the handle.

FIG. 14 is a cross-section of a powder homogenizing device, following attachment to the handle.

FIG. 15 is a cross-section of a powder homogenizing device including an annular step, following attachment to the handle.

FIG. 16 is a schematic perspective view showing a homogenizing operation of shaking a handle.

FIGS. 17 and 18 are schematic exploded perspective views 1-2 of a powder homogenizing device including distributing needles disposed therein.

FIG. 19 is a schematic perspective view of a powder homogenizing device including distributing needles, prior to attachment to the handle.

FIG. 20 is a schematic perspective view of a powder homogenizing device including distributing needles, prior to attachment to a handle by rotation in a first direction.

FIG. 21 is a cross-section of a powder homogenizing device including distributing needles, following attachment to a handle by rotation in a first direction.

FIG. 22 is a schematic perspective view of a powder homogenizing device including distributing needles, following attachment to a handle by rotation in a second direction.

FIG. 23 is a cross-section of a powder homogenizing device in which a cup portion is rotatable with respect to the flange portion, following attachment to a handle by rotation in a second direction.

FIG. 24 is an enlarged view of the portion A in FIG. 23.

FIG. 25 is a schematic perspective view of a powder homogenizing device including a powder distribution component observed from the opening.

FIG. 26 is a schematic cross-sectional view of a powder homogenizing device including a powder distribution component.

FIG. 27 is a schematic perspective view of a powder distribution component having a blade shape.

FIG. 28 is a schematic side view of a powder distribution component having a blade shape.

FIG. 29 is a schematic perspective view of a powder distribution component having a loop-shaped wire.

### DETAILED DESCRIPTION

The following disclosure provides numerous different embodiments or examples used to implement the features of the provided subject matter, and will describe specific examples of components and configurations to simplify this disclosure. Of course, these are merely examples and are not intended to be limiting. For instance, in the descriptions that follow, “forming a first component on or above a second component” may include embodiments where the first component and the second component are in direct contact, as well as embodiments where additional components may be formed between the first and second components, allowing the first and second components to not be in direct contact. Furthermore, this disclosure may repeat component symbols and/or letters across various examples. This repetition is intended for simplification and clarity and does not, in itself, indicate any relationship between the various embodiments and/or configurations being discussed.

Additionally, for the sake of convenience in description, spatial relative terms (such as “below,” “beneath,” “down,” “above,” “up,” “on top,” and similar expressions) may be used in this document to describe the relationship between one component or part and another (or others), as illustrated in the figures. Beyond the orientations depicted in the figures, these spatial relative terms are also intended to encompass different orientations of the device during use or operation. The device or component may be oriented in other ways (such as rotated 90 degrees or in other orientations), and the spatial relative descriptors used in this document may be interpreted accordingly.

As used in this disclosure, terms such as “first,” “second,” and “third” describe various components, assemblies, regions, layers, and/or sections. These components, assemblies, regions, layers, and/or sections should not be limited by these terms. Such terms are used solely for the purpose of distinguishing between the components, assemblies, regions, layers, or sections. Unless explicitly indicated otherwise in the text, the terms “first,” “second,” and “third” used herein do not imply any sequence or order.

In this disclosure, the terms “approximately,” “substantially,” “substantial,” and “about” are used to describe and explain small variations. When used in conjunction with an event or situation, these terms may refer to specific instances in which the event or situation occurs precisely, as well as instances where the occurrence is very similar. For example, when used in conjunction with a numerical value, these terms may refer to a range of variation of ±10% of that value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For instance, if the difference between two values is less than or equal to ±10% of the average of those values (such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), then those values may be considered “substantially” the same or equal. For example, “substantially” parallel may involve a range of angular variation of less than or equal to ±10° relative to 0°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. Similarly, “substantially” vertical may involve a range of angular variation of less than or equal to ±10° relative to 90°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to =0.05°.

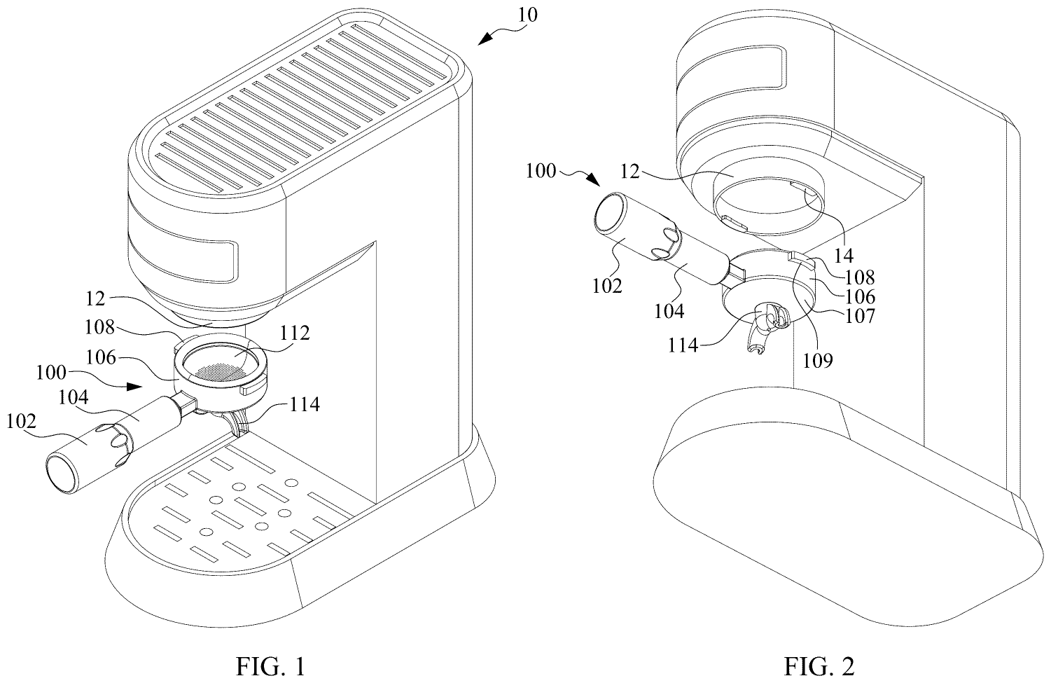

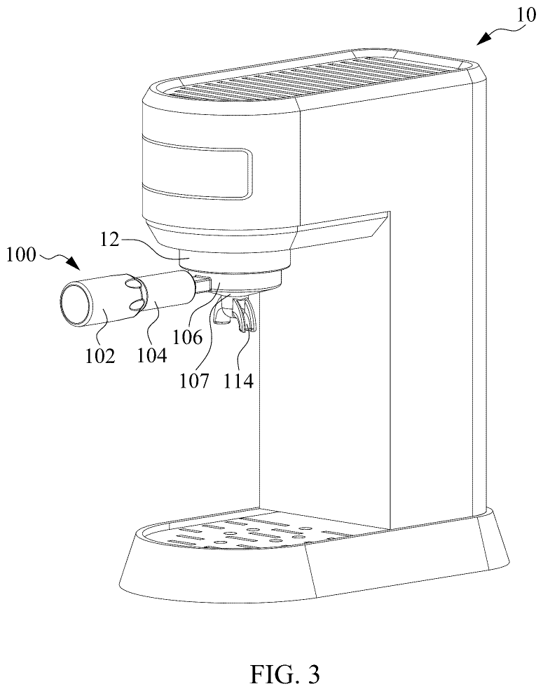

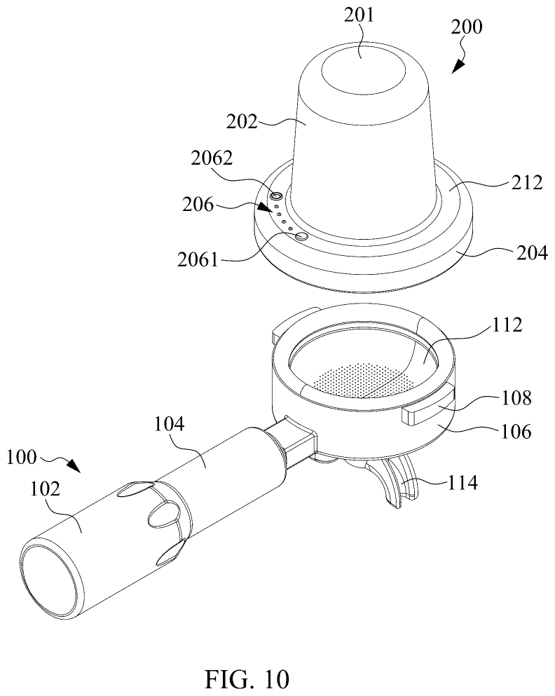

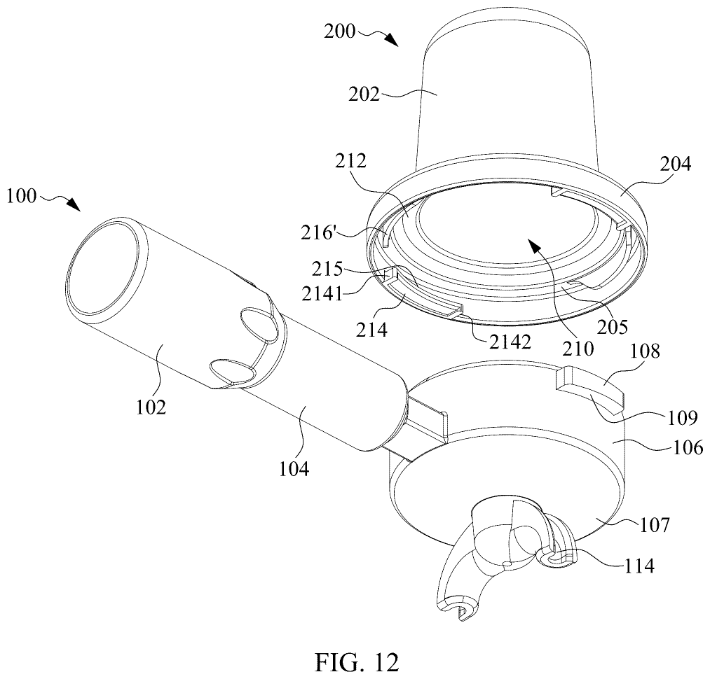

In this disclosure, unless otherwise specified, “upper” and “lower” refer to relative directions based on the positions of a coffee machine 10 and a handle 100 as shown in FIG. 1. This directional representation can be easily understood by one skilled in the art, based on a coffee machine placed on a workbench. For example, the handle 100 shown in FIGS. 1 and 2 is located “below” the connection port 12 of the coffee machine 10, the basket portion 112 shown in FIGS. 4 and 5 is located “above” the handle 100, and the powder homogenizing device 200 shown in FIGS. 11 to 13 is located “above” the handle 100. Similarly, unless otherwise specified, the terms “lateral,” “horizontal,” and “vertical” also have analogous orientational relationships.

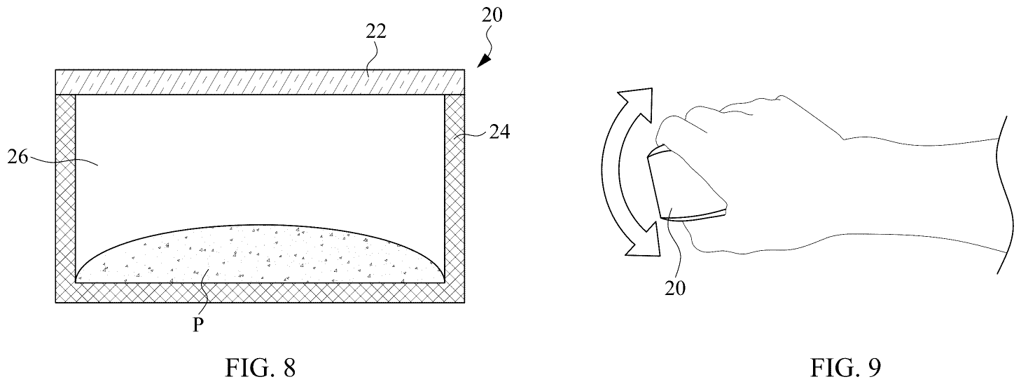

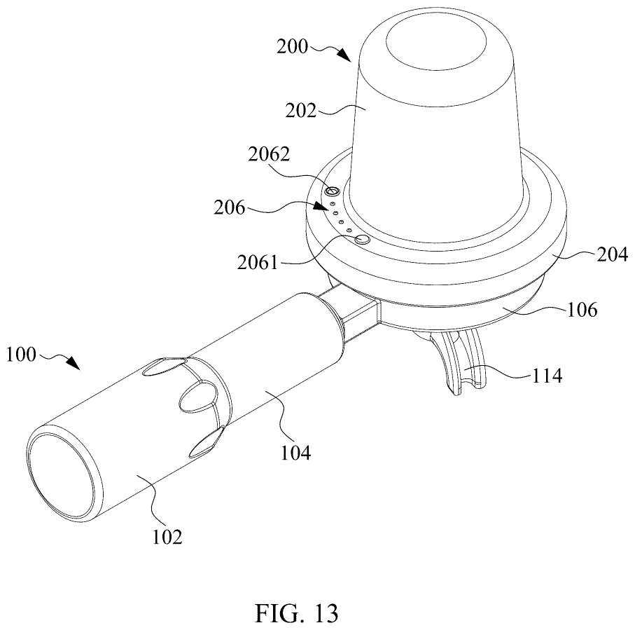

Please refer to FIGS. 10 to 14. The disclosure provides powder homogenizing device 200, which is efficient, convenient, and labor-saving. The powder homogenizing device 200 comprises a cup portion 202, a flange portion 212, and a coupling portion 204. The cup portion 202 has an opening 210 disposed therein and is generally shaped like a flat-bottomed cone that gradually widens from a flat base 201 to the diameter of the opening 210. The flange portion 212 extends radially outward from the edge of the opening 210 of the cup portion 202. The coupling portion 204 extends from an outer edge of the flange portion 212 along a direction away from the cup portion 202. As shown in FIG. 14, when the powder homogenizing device 200 covers the basket portion 112 of the handle 100, the coupling portion 204 attaches the powder homogenizing device 200 to the handle 100, with the flange portion 212 resting against the top edge 113 of the powder cup 112. This configuration allows the cup portion 202 of the powder homogenizing device 200 and the basket portion 112 of the handle 100 to collectively form a chamber 208 for holding powder. During operation, coffee powder can be filled into the cup portion 202 through the opening 210, or it can be placed into the basket portion 112 before inverting the powder homogenizing device 200 onto the basket portion 112 and handle 100.

The coupling portion 204 of the powder homogenizing device 200 is equipped with a latching structure, which engages with the connection portion 108 of the handle 100, thereby fastening the powder homogenizing device 200 to the handle 100. According to one embodiment of this disclosure, the latching structure of the coupling portion 204 is a tab 214, which extends radially inward from the inner side of the coupling portion 204 by a predetermined distance. At least a part of an upper surface 215 of the tab 214 includes a sloped plane corresponding to a sloped plane on the lower surface of the handle. When the powder homogenizing device 200 is rotationally engaged with the handle 100 through the interaction of these two sloped planes, the connection portion 108 of the handle 100 is positioned above the tab 214. In some embodiments of this disclosure, a gasket is included between the flange portion 212 of the powder homogenizing device 200 and the top edge 113 of the basket portion 112, creating a seal between the handle 100 and the powder homogenizing device 200.

As shown in FIG. 14, the diameter of the opening 210 of the cup portion 202 is less than or equal to the maximum inner diameter D of the basket portion 112. This ensures that when the powder homogenizing device 200 is attached to the handle 100, all the powder located in the chamber 208 will fall into the basket portion 112 as long as the opening 210 is facing downward, and no powder will leak out of the chamber 208. Furthermore, as will be described later, the powder is directly placed into the basket portion 112 in a homogenized state, which helps to minimize any disruption to the homogenized state as the powder falls into the basket portion 112 due to gravity. The cup portion 202 of the powder homogenizing device 200 preferably has a depth that is 2 to 5 times that of the powder cup 112, wherein the chamber 208 has sufficient space to allow the powder to tumble within it.

As shown in FIG. 11, the coupling portion 204 has at least one stopper 216 disposed thereon. The stopper 216 is a thin wall perpendicular to the flange portion 212 and the coupling portion 204. The stopper 216 is positioned on the inside of the coupling portion 204, adjacent to a first side 2141 of the tab 214 at a distance less than the width of the connection portion 108 of the handle 100. This arrangement allows the connection portion 108 of the handle 100 to be screwed over the tab 214 only from a second side 2142, which is opposite the first side 2141, in a direction towards the first side 2141. When the powder homogenizing device 200 is attached to the handle 100, the stopper 216 is located at the lateral position of the connection portion 108 of the handle 100.

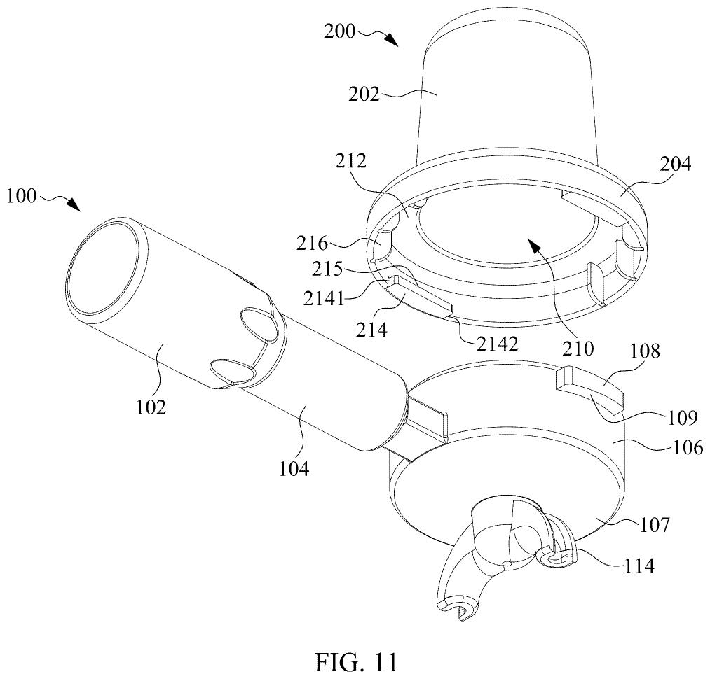

The flange portion 212 may further include stoppers. As shown in FIG. 11, adjacent to the first side 2141 of each tab 214, there are three stoppers 216. The three stoppers 216 are arranged along the rotational direction of the aforementioned screw-in connection portion 108 from the first side 2141 of the tab 214, with a space less than the width of the connection portion 108 of the handle 100. These stoppers 216 can limit the rotational angle when the powder homogenizing device 200 is inverted onto the handle 100. In the embodiment shown in FIG. 11, the connection portion 108 of the handle 100 can only be fitted into the powder homogenizing device 200 between the second side 2142 and the stopper 216 adjacent to the second side 2142, and then rotated onto the tab 214. In other embodiments disclosed herein, the number of the aforementioned at least one stopper 216 may vary. Further, as shown in FIG. 12, between each tab 214, there is only one stopper 216′. The stopper 216′ can extend a certain circumferential distance on the coupling portion 204 or the annular step 205 (as described later), and can similarly achieve the function of the stopper 216 which limits the relative rotation between the powder homogenizing device 200 and the handle 100 shown in FIG. 11.

When the connection portion 108 of the handle 100 is screwed onto the tab 214 in the allowed rotational direction, the connection portion 108 is lifted due to the sloped plane of the lower surface 109 of the connection portion 108 and/or the sloped plane of the tab 214 itself relative to the horizontal direction. This lifting action reduces the gap between the top edge 113 of the basket portion 112 and the flange portion 212 until the top edge 113 of the basket portion 112 contacts the flange portion 212, thereby stopping the rotation.

According to the embodiment illustrated in FIGS. 11 to 13, when the powder homogenizing device 200 is installed on the handle 100, it can only rotate within a limited angle range. In accordance with one embodiment of this disclosure, the powder homogenizing device 200 may further include an indicator 206 thereon. The indicator is used to indicate the degree of engagement between the powder homogenizing device 200 and the handle 100. As shown in the figures, when the first marking 2061 of the indicator 206 aligns with the rod portion 104 of the handle 100, the powder homogenizing device 200 can be disposed onto or detached from the handle 100. When the second marking 2062 of the indicator 206 aligns with the rod portion 104 of the handle 100, it indicates that the powder homogenizing device 200 is in a secured position and is abutting against the stopper 216.

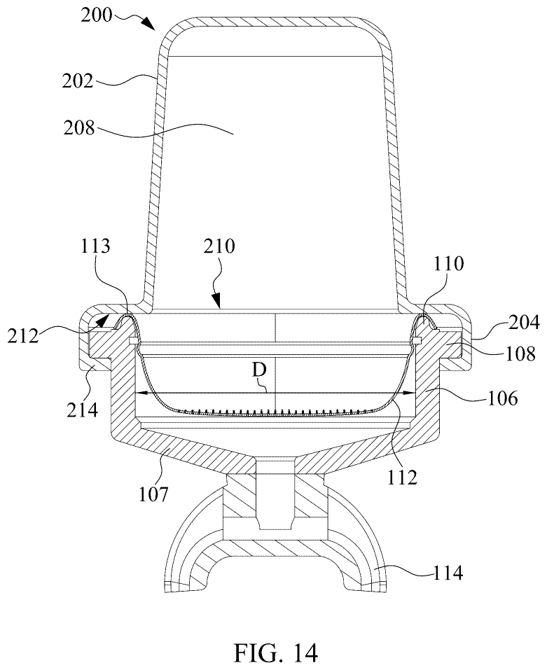

Please refer to FIG. 15, which illustrates another embodiment of this disclosure, the powder homogenizing device 200′. The powder homogenizing device 200′ has a structure similar to that of the powder homogenizing device 200, with the difference being that, in this embodiment, the flange portion 212′ of the powder homogenizing device 200′ includes an annular step 205. The inner edge of the annular step 205 can abut at least a portion of the outer peripheral surface 115 of the coffee basket, the outer peripheral surface 115 being extended radially outward from the top edge 113 of the basket portion 112. The annular step 205 ensures that the opening 210′ of the powder homogenizing device 200′ is concentric with the basket portion 112, so that when the opening 210′ faces downward, it can be ensured that the powder falls entirely into the basket portion 112. One skilled in the art understands that the outer ring portion 106 of the handle 100 may have various sizes, possibly slightly larger or slightly smaller than the maximum diameter of the powder cup 112. The annular step 205 of the powder homogenizing device 200′ directly positions the powder homogenizing device based on the position of the basket portion 112, ensuring that the opening 210′ of the powder homogenizing device 200′ is concentric with the basket portion 112, regardless of the dimension of the handle 100 that is used.

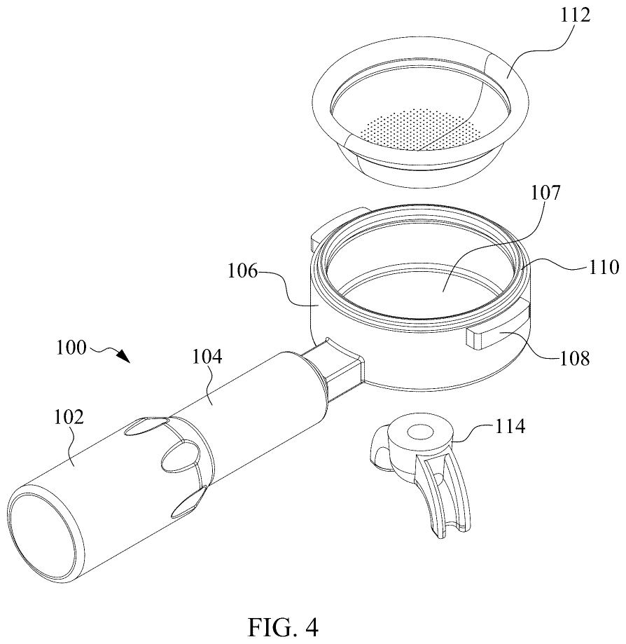

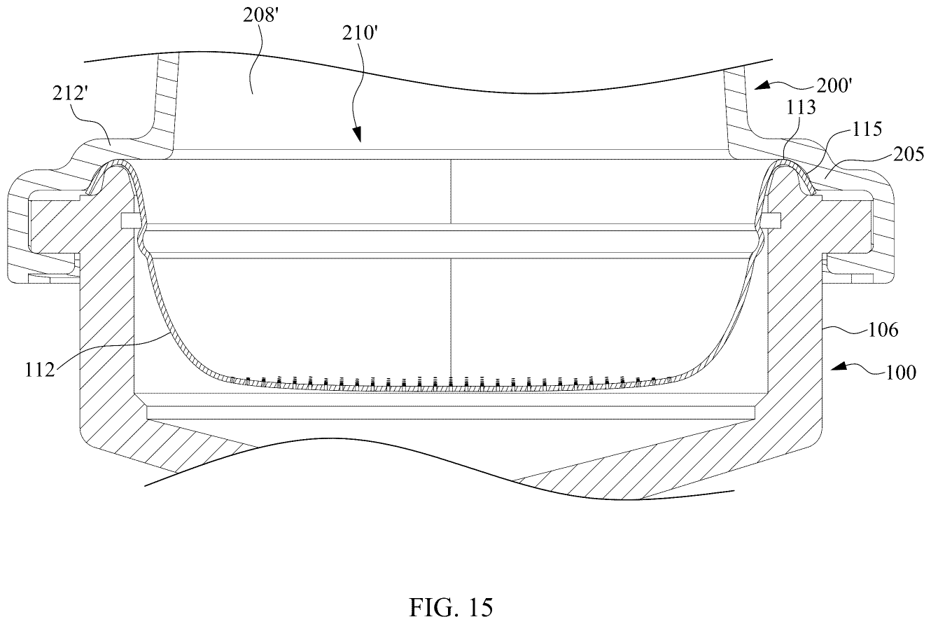

FIG. 16 illustrates a method of powder homogenization using the disclosed powder homogenizing device 200, which includes the following steps. Powder is paced into the basket portion 112 of the handle 100 or into the powder homogenizing device 200, the powder homogenizing device 200 is attached to the handle 100, and the handle 100 is shaken. As shown in FIG. 16, the user can grip the grip 102 of the handle 100, tilt and shake the handle 100, and upon completion of homogenization, remove the powder homogenization device 200. The homogenized powder is then entirely retained in the basket portion 112. After homogenization, the user can directly install the handle 100, which includes the powder cup 112, onto the coffee machine 10 (see FIGS. 1-6) to proceed with coffee brewing.

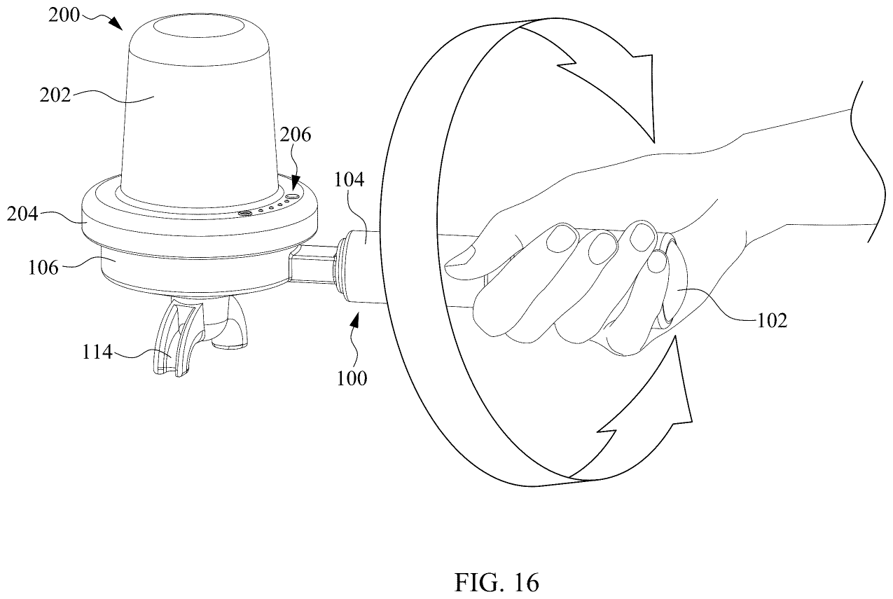

FIGS. 17-19 illustrate another powder homogenizing device 300 according another embodiment of this disclosure. The powder homogenizing device 300 is assembled from a first part 300A and a second part 300B. The first part 300A includes a cup portion 302 and a flange portion 312, while the second part 300B includes a coupling portion 304. Inside the cup portion 302 of the powder homogenizing device 300, there are multiple needles 301. One end of each needle is fixed at the bottom of the cup portion 302. These needles extend from the bottom, approximately vertically, towards the opening 310 of the powder homogenizing device 300. The flange portion 312 of the first part 300A is coupled to the opening 310 of the second part 300B and engages with clasps 313, being held between the clasps 313 and a step 315 of the first part 300A.

In addition, the inner diameter of the annular portion 311 of the second part 300B is approximately equal to the outer diameter of the cup portion 302 of the first part 300A. This allows the first part 300A and the second part 300B to maintain concentricity when assembled together. The vertical distance between the clasps 313 and the step 315 is slightly greater than the thickness of the flange portion 312. Therefore, in the absence of external forces (e.g., the normal force generated by leaning against the basket portion), the first part 300A and the second part 300B can rotate relative to each other after assembly.

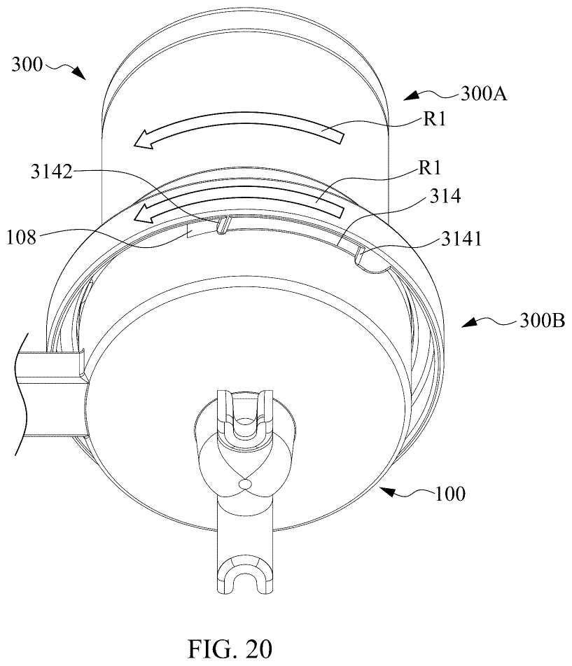

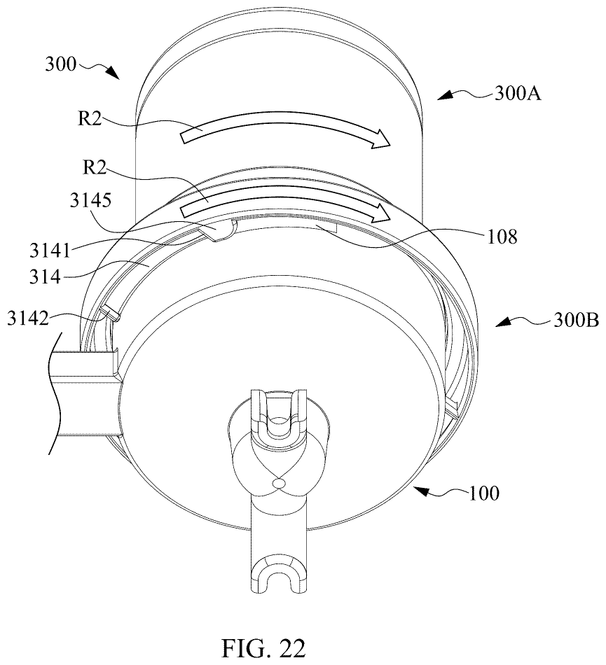

After assembling the first part 300A and the second part 300B, the needles 301 extend beyond the flange portion 312 but do not exceed the opening 310. This design allows the needles 301 to extend into the space of the basket portion 112 that holds the coffee grounds when the powder homogenizing device 300 is installed on the handle 100, or, when the basket portion 112 contains powder, the needles can at least contact the upper surface of the powder and reach a predetermined distance downward from that surface. Specifically, as shown in FIGS. 21 and 23, one fixed end of each of these needles 301 is secured to the bottom of the cup portion 302, while the free end of each of these needles 301 extends between the coupling portion 304 of the powder homogenizing device 300. The needles 301 can be fixed to the bottom of the cup portion 302 by means of multiple fixing seats 321 and a plate 319 installed within the cup portion 302.

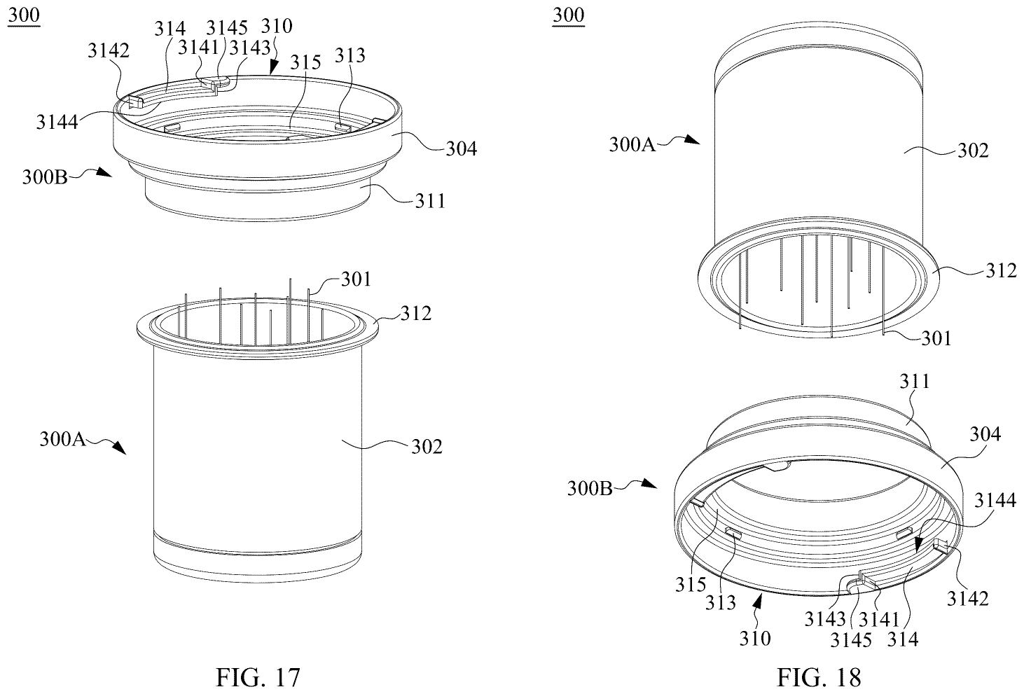

Similarly, the coupling portion 304 of the powder homogenizing device 300 includes at least one tab 314 to engage with the connection portion 108 of the handle 100. As shown in FIGS. 19, 22, and 23, the tab 314 of the powder homogenizing device 300 has a first side 3141 and a second side 3142. The surface of the tab 314 facing the flange portion 312 is a sloped plane 3144. This sloped plane 3144 causes the tab 314 to gradually approach the flange portion 312 from the second side 3142 to the first side 3141. Specifically, the distance between the first side 3141 of the tab 314 and the flange portion 312 is slightly less than the thickness of the connection portion 108 of the handle 100, while the distance between the second side 3142 of the tab 314 and the flange portion 312 is slightly greater than the thickness of the connection section 108 of the handle 100.

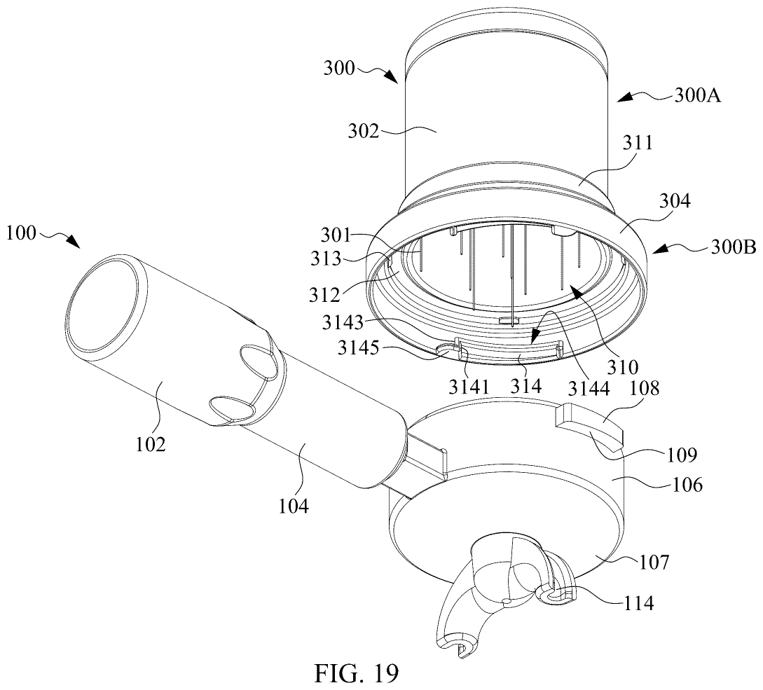

Similar to the tabs 214 of the powder homogenizing device 200 of FIGS. 20 and 21, the powder homogenizing device 300 only allows the connection portion 108 to be screwed onto the tab 314 from the second side 3142 of the tab 314 in the first rotation direction R1, and is clamped between the tab 314 and the flange portion 312. The term “clamped” here refers to the lifting of the connection portion 108 of the handle 100 in the first rotation direction R1 by the sloped plane 3144, causing the flange 110 to press the basket portion 112 against the flange portion 312. Meanwhile, the handle 100 and the basket portion 112 are respectively pressed against the flange portion 312 of the first part 300A and the tab 314 of the second part 300B, with the flange portion 312 resting against the step 315. In conclusion, after the powder homogenizing device 300 is installed onto the handle 100, rotating the powder homogenizing device 300 in the first rotation direction R1 secures the powder homogenizing device 300 onto the handle 100 and seals the space formed by the cup portion 302 and the basket portion 112. Additionally, neither the first part 300A nor the second part 300B of the powder homogenizing device 300 can continue to rotate in the first rotation direction R1.

Please refer to FIG. 19. The first side 3141 of the tab 314 includes a wall 3143 extending from the sloped plane 3144 in a direction perpendicular to the flange portion 312, and a platform 3145 extending from one end of the wall 3143, opposite the sloped plane 3144, in a direction parallel to the flange portion 312.

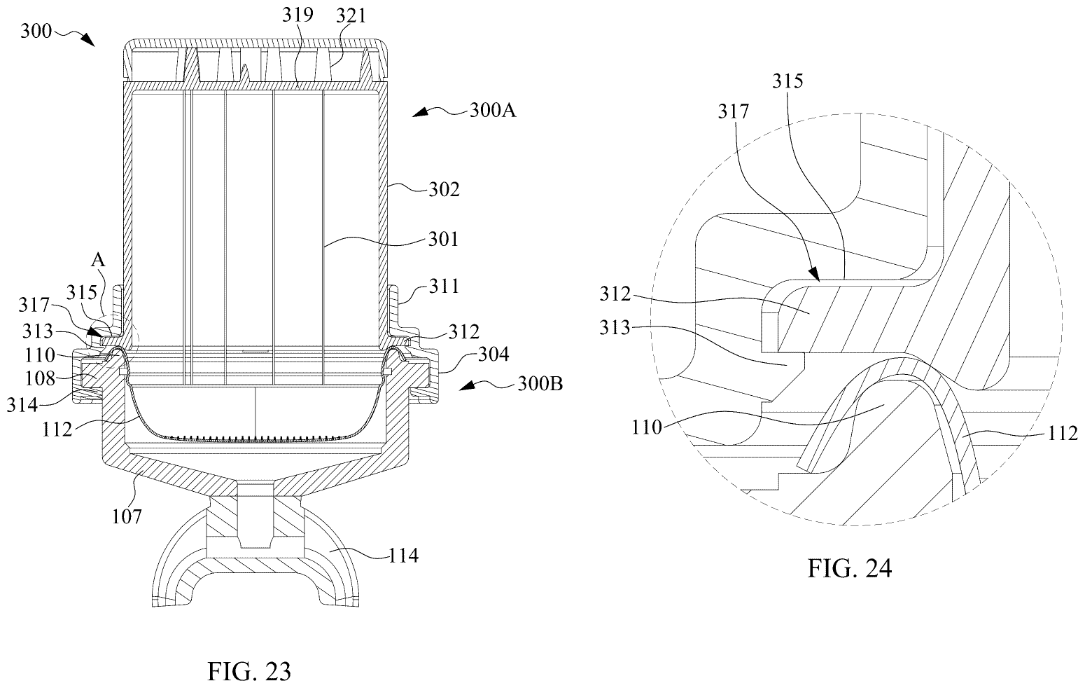

When the powder homogenizing device 300 is installed on the handle 100 and rotated in the second rotation direction R2, the connection portion 108 of the handle 100 cannot enter the tab 314. The rotation of the second part 300B of the powder homogenizing device 300 is stopped by the wall 3143 of the first side 3141 of the tab 314, and the lower part of the connection portion 108 of the handle 100 can rest on the platform 3145 extending from the first side 3141 of the tab 314. The distance between the platform 3145 and the flange portion 312 is greater than the thickness of the connection portion 108 of the handle 100. This means that when the connection portion 108 of the handle 100 rests on the platform 3145, the basket portion 112 does not press against the flange portion 312. As previously mentioned, the vertical distance between the clasps 313 of the second part 300B and the step 315 is slightly greater than the thickness of the flange portion 312 of the first part 300A. Therefore, when the basket portion 112 does not press against the flange portion 312, there is a slight gap 317 between the flange portion 312 and the step 315 (particularly visible in FIG. 24), allowing the first part 300A to continue rotating in the second rotation direction R2 without being affected by the termination of the rotation of the second part 300B.

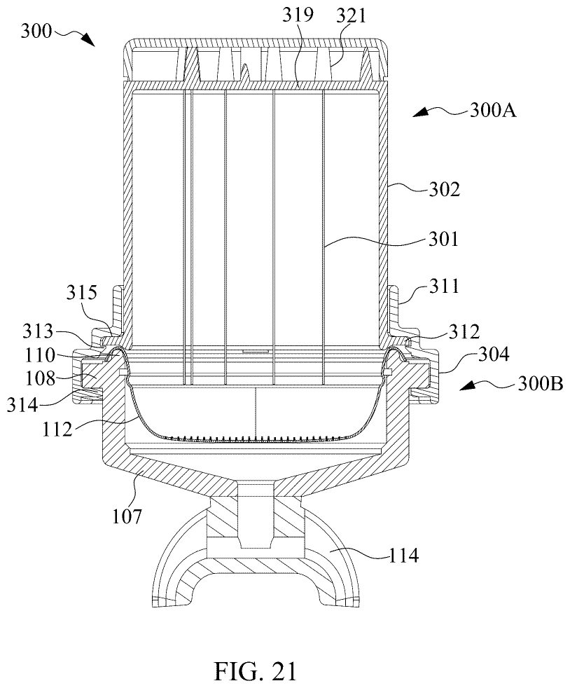

It can thus be understood that with the use of the powder homogenizing device 300, the user first places the powder homogenizing device 300 onto the handle 100. By rotating the powder homogenizing device 300 in the first rotation direction R1, the device can be locked onto the handle 100, sealing the basket portion 112. After that, simply shaking the handle 100 will result in the homogenization of the coffee powder. Subsequently, by rotating the powder homogenizing device 300 in the second rotation direction R2, as shown in FIG. 22, the needles 301 within the first part 300A can distribute the coffee powder inside the basket portion 112. Notably, the design of the wall 3143 and platform 3145 on the first side 3141 of the tab 314 allows the connection portion 108 of the handle 100 to help secure the second part 300B when the powder homogenizing device 300 is rotated in the second rotation direction R2. This enables the user to conveniently continue rotating the first part 300A for powder distribution without worrying about the powder homogenizing device 300 detaching from the handle 100.

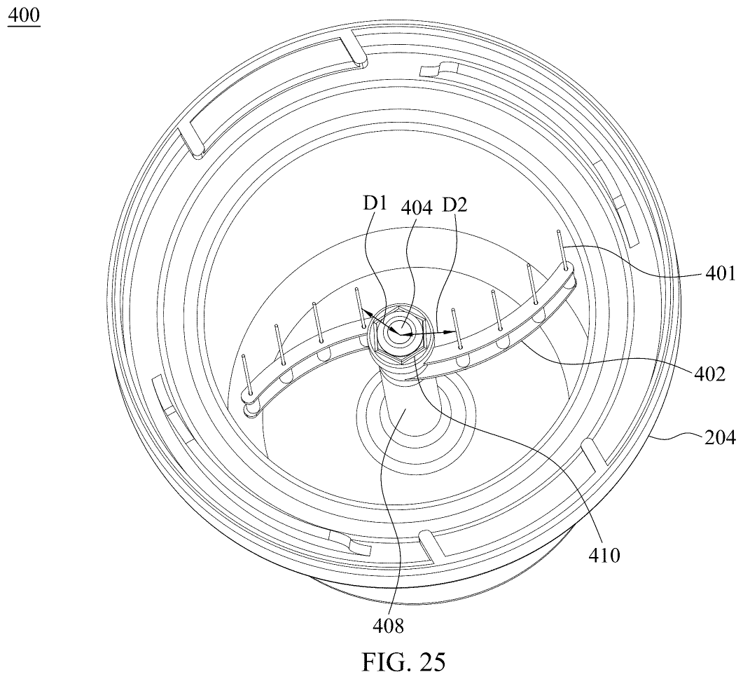

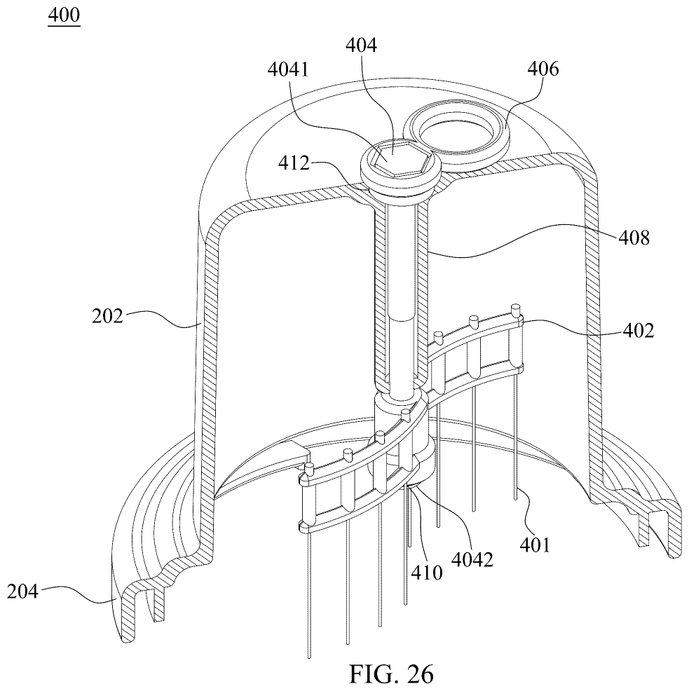

FIGS. 25 to 26 illustrate a powder homogenizing device 400 according to another embodiment of this disclosure. The powder homogenizing device 400 has a structure similar to the aforementioned powder homogenizing device 200, in which a cup portion 202 and the coupling portion 204 cannot rotate relative to each other. The powder homogenizing device 400 includes a rotating shaft 404 and a rotating arm 402 fixed thereon. The rotating shaft 404 has an elongated body that is rotatably fixed at the central bottom position of the cup portion 202. The first end 4041 of the rotating shaft 404 is located outside the cup portion 202, and the second end 4042 of the rotating shaft 404 extends into the interior of the cup portion 202. The outer surface of the cup portion 202 has a groove 412, which can be used to set one end of a rocker arm 406 and the first end 4041 of the rotating shaft 404. More specifically, the rocker arm 406 can be mounted on the groove 412 via a non-circular flange at the first end 4041 of the rotating shaft 404. This allows the user to rotate the rocker arm 406 from outside the cup portion 202 to drive the rotation of the rotating shaft 404. Preferably, the other end of the rocker arm 406 has a ring that facilitates operation by the user's fingers.

In the direction opposing the groove 412, i.e., the inside of the cup portion 202, the cup portion 202 includes a long, straight hollow sleeve 408, designed to accommodate the rotating shaft 404 therein. The rotating shaft 404 can be secured at the second end 4042 by a fastener 410, for example, by using a bolt to fix the rotating shaft 404 at the end of the hollow sleeve 408.

The needles 401 used for the powder distribution are fixed on the rotating arm 402, and their free ends extend into the coupling portion 204. When the powder homogenizing device 400 is installed on the handle 100, the free ends of these needles 401 extend into the basket portion 112. The rotating arm 402 is vertically positioned at the second end 4042 adjacent to the rotating shaft 404. When the user rotates the rotating shaft 404 from outside the powder homogenizing device 400, the rotating arm 402 and needles 401 are simultaneously rotated to distribute the powder. The powder homogenizing device 400 can have more than one rotating arm 402, with the needles 401 preferably fixed at equal intervals on each rotating arm 402. In cases where there is more than one rotating arm 402, such as the two rotating arms shown in FIG. 25, the distance of each needle on the respective rotating arms 402 from the rotating shaft 404 (or from the center of the bottom of the cup portion 202) may vary. For example, as shown in FIG. 25, the distance D1 is less than the distance D2, allowing the needles 401 to sweep over as large an area as possible during rotation to achieve an optimal powder distribution effect.

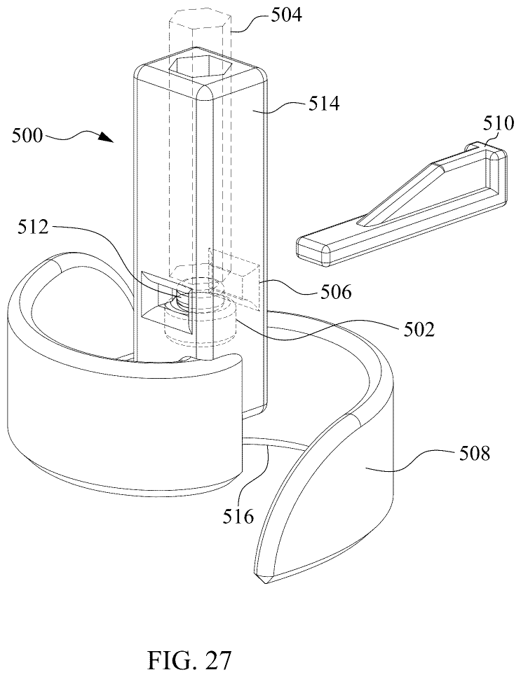

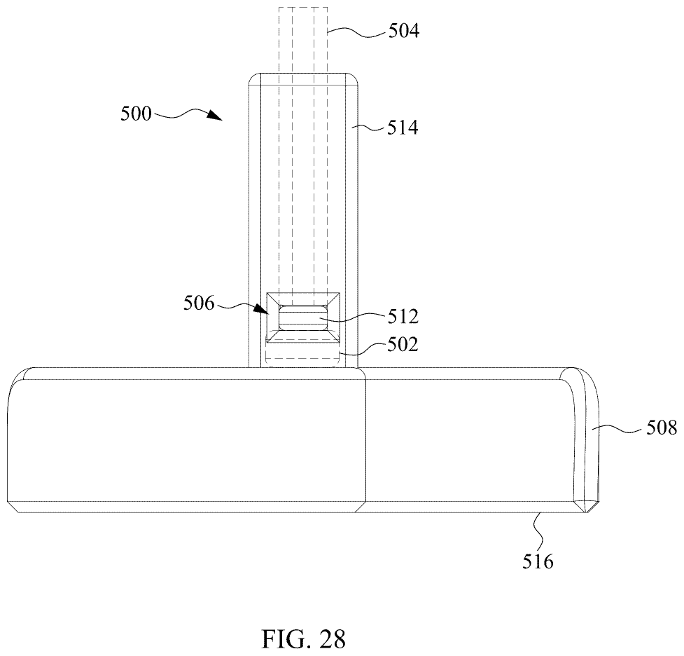

FIGS. 27 and 28 illustrate a powder distribution component 500 according to one embodiment of this disclosure. The powder distribution component 500 can be mounted on a powder homogenizing device via a rotating shaft 504. The rotating shaft 504 extends from the exterior to the interior of the powder homogenizing device, allowing the user to operate the powder distribution component 500 from outside the powder homogenizing device. The powder distribution component 500 includes a sleeve 514 that receives the rotating shaft 504. The sleeve 514 has a non-circular inner aperture which matches the shape of the rotating shaft 504, enabling the powder distribution component 500 to be driven by the rotating shaft 504. The sleeve 514 can be coupled to the rotating shaft 504 via any appropriate fasten means. The bottom of the sleeve 514 contains a metal block 502 therein. At least one of the rotating shaft 504 and the metal block 502 is made of a magnetic material, and the other is made of a ferromagnetic material, allowing the powder distribution component 500 to be magnetically attached to the rotating shaft 504 via the interaction between the metal block 502 and the rotating shaft.

Unlike the aforementioned needles used for powder distribution, the powder distribution component 500 distributes powder by contacting the surface of the powder by at least one blade 508, the powder distribution component 500 including two blades 508. The blades 508 extend radially outward in a helical manner, gradually moving away from the sleeve 514. When the powder distribution component 500 rotates in the direction in which the concave curve moves forward, these helically extending blades can direct the powder towards the center of the container. Similarly, when the powder distribution component 500 rotates in the direction in which the convex curve moves forward, these blades can spread powder away from the center. Additionally, the lower edge 516 of the blades 508 is curved, and thus, during rotation, this lower edge can compact the surface of the powder.

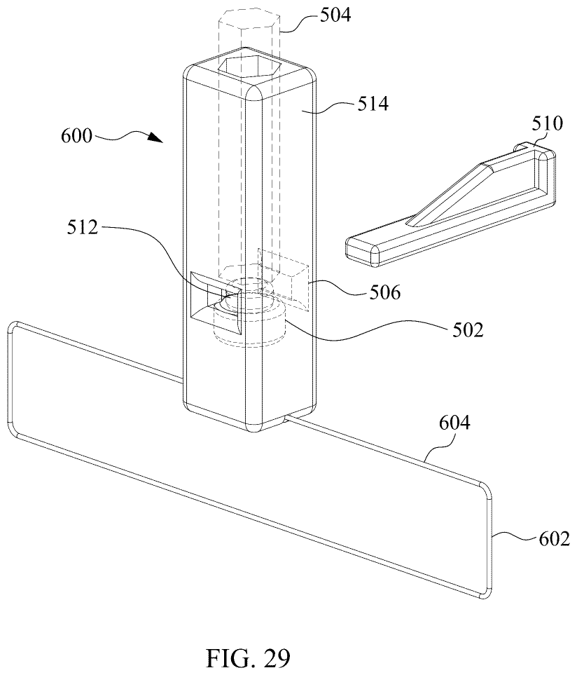

As mentioned, at least one of the rotating shaft 504 and the metal block 502 is magnetic material. Thus, if the user wants to adjust the distance that the powder homogenizing component 500 extends into the basket portion 112 (it affects the interaction between the blades 508 and the surface of the powder), the user can simply adjust the distance that the rotating shaft 504 is inserted into the sleeve 514 by placing one or more small blocks 512 made of ferromagnetic materials. Further, the sleeve of the powder distribution component 500 includes two lateral through holes 506 above the metal block 502. Thus, when removing the small blocks 512 from the sleeve 514, the user can use a tool (e.g., a toothpick or a pushing tool 510 shown in FIGS. 27 and 29) to push the small block 512 though the two lateral through holes 506.

FIG. 29 shows a powder distribution component 600 according to another embodiment of this disclosure. The powder distribution component 600 differs from the powder distribution component 500 in that, instead of using the blades 508, the powder distribution component 600 utilizes a loop-shaped wire 604 to distribute the powder. Specifically, when the powder distribution component 600 rotates, the loop-shaped wire 604 contacts the surface of the powder and distributes it.

As shown in FIG. 29, the loop-shaped wire 604 can be attached to the sleeve 514 in the shape of a rectangular frame 602. However, the powder distribution component 600 may have other configurations, such as an inverted ‘T’ shape frame or an inverted ‘TT’ shape frame.

We claim:

1. A powder homogenizing device, comprising:
a cup portion having an opening therein;
a flange portion extending radially and outwardly from a circumferential edge of the opening of the cup portion; and
a coupling portion extending from an outer edge of the flange portion in a direction away from the cup portion, wherein the coupling portion has a latching structure thereon, the latching structure configured to connect with a connection portion of a handle for brewing coffee, allowing the coupling portion to couple to the connection portion of the handle, and
wherein, when the coupling portion of the powder homogenizing device is coupled to the handle, the flange portion of the powder homogenizing device abuts a top edge of a basket portion of the handle, such that the cup portion of the powder homogenizing device and the basket portion of the handle collectively form a chamber for containing powder.

2. The powder homogenizing device according to claim 1, wherein the flange portion has an annular step, an inner edge of the annular step being configured to abut at least a portion of an outer peripheral surface of the basket portion, the outer peripheral surface being extended radially outward from the top edge of the basket portion.

3. The powder homogenizing device according to claim 1, wherein a maximum inner diameter of the opening of the cup portion is less than or equal to a maximum inner diameter of the basket portion.

4. The powder homogenizing device according to claim 1, wherein the flange portion of the powder homogenizing device comprises at least one identifier disposed thereon, the at least one indicator indicating a degree of engagement between the powder homogenizing device and the handle.

5. The powder homogenizing device according to claim 1, wherein
the latching structure of the coupling portion is a tab, which extends radially inward a predetermined distance from an inner side of the coupling portion, wherein
at least a portion of an upper surface of the tab has a sloped plane corresponding to a lower surface of the connection portion of the handle, and wherein
when the powder homogenizing device is attached to the handle, the connection portion of the handle is positioned above the tab.

6. The powder homogenizing device according to claim 1, wherein the cup portion comprises a plurality of needles therein, which can be rotated about an axis of the cup portion relative to the coupling portion, wherein free ends of the plurality of needles extends into an area surrounded by the coupling portion.

7. The powder homogenizing device according to claim 6, wherein
the powder homogenizing device is composed of a first part and a second part, the first part including the cup portion and the flange portion and the second part including the coupling portion, an inner side of the coupling portion including clasps and an annular step spaced apart from the clasps, and wherein
the first part and the second part are assembled in a manner that allows them to rotate relative to each other.

8. The powder homogenizing device according to claim 7, wherein
the first part is secured to the second part with a portion of the flange portion being held between clasps and a step of the second part, and wherein
a vertical distance between the clasps and the step is greater than a thickness of the flange portion.

9. The powder homogenizing device according to claim 7, wherein
the second part comprises a tab, which extends radially inward a predetermined distance from the inner side of the coupling portion, the tab comprising:
a first side;
a second side opposite the first side; and
a sloped plane disposed between the first side and the second side, the sloped plane facing toward the flange portion, wherein
at the first side, a distance between the sloped plane and the flange portion is less than a thickness of the connection portion of the handle, and, at the second side, a distance between the sloped plane and the flange portion is greater than the thickness of the connection portion of the handle.

10. The powder homogenizing device according to claim 9, wherein the tab of the second part comprises:
a wall extending vertically from the sloped plane towards the flange portion; and
a platform extending from an end of the wall opposite the sloped plane along a direction parallel to the flange portion.

11. The powder homogenizing device according to claim 9, wherein the second part comprises an annular portion, which is configured to accommodate the cup portion of the first part, wherein an inner diameter of the annular section of the second part is approximately equal to the outer diameter of the cup portion of the first part, so as to maintain concentricity between the first part and the second part.

12. The powder homogenizing device according to claim 1, further comprising:
a rotating shaft rotatably coupled to a bottom center of the cup portion, the rotating shaft including:
a first end pivotally disposed outside the cup portion; and
a second end opposite the first end, the second end being located inside the cup portion; and
a powder distribution component coupled to the second end of the rotating shaft, such that the powder distribution component can be rotated inside the powder homogenizing device by operating the first end of the rotating shaft.

13. The powder homogenizing device according to claim 12, wherein the powder distribution component comprises:
a sleeve coupled to the second end of the rotating shaft;
at least one rotating arm extending from the sleeve of the powder distribution component; and
a plurality of needles fixed to the at least one rotating arm at intervals, wherein
free ends of the plurality of needles extends into an area surrounded by the coupling portion.

14. The powder homogenizing device according to claim 12, further comprising a rocker arm, one end the rocker arm being fixed to the first end of the rotating shaft and another end of the rocker arm being configured to be operated by a user's finger.

15. The powder homogenizing device according to claim 13, wherein the distances between each of the needles and a center of the cup portion may vary.

16. The powder homogenizing device according to claim 12, wherein the rotating shaft is non-circular, and wherein the powder distribution component comprises:
a sleeve having a first end and a second end, the first end of the sleeve including an opening configured to receive the rotating shaft;
a metal block positioned at the second end inside the sleeve, wherein at least one of the rotating shaft and the metal block is made of a magnetic material and the other is made of a ferromagnetic material;
a hole being located laterally through the sleeve on the side adjacent to the metal block.

17. The powder homogenizing device according to claim 16, wherein the powder distribution component comprises one or more small blocks disclosed in the sleeve, wherein the one or more small blocks are made of magnetic material or ferromagnetic materials.

18. The powder homogenizing device according to claim 12, wherein the powder distribution component comprises:
a sleeve coupled to the second end of the rotating shaft; and
at least one helical blade extending from the sleeve.

19. The powder homogenizing device according to claim 12, wherein the powder distribution component comprises:
a sleeve coupled to the second end of the rotating shaft; and
a loop-shaped wire attached to the sleeve.

20. A method of homogenizing powder, comprising:
providing a handle for brewing coffee;
providing a powder homogenizing device, which comprises:
a cup portion having an opening therein;
a flange portion extending radially and outwardly from a circumferential edge of the opening of the cup portion; and
a coupling portion extending from an outer edge of the flange portion in a direction away from the cup portion, wherein the coupling portion has a latching structure thereon, the latching structure configured to connect with a connection portion of a handle for brewing coffee, allowing the coupling portion to couple to the connection portion of the handle, and
wherein, when the coupling portion of the powder homogenizing device is coupled to the handle, the flange portion of the powder homogenizing device abuts a top edge of a basket portion of the handle, such that the cup portion of the powder homogenizing device and the basket portion of the handle collectively form a chamber for containing powder;
placing powder into the basket portion of the handle or the powder homogenizing device;
attaching the powder homogenizing device to the handle; and
shaking the handle.

21. The method according claim 20, wherein
the powder homogenizing device includes a plurality of needles or a powder distribution component therein, the plurality of needles or the powder distribution component being configured to contact the powder placed in the basket portion when the powder homogenizing device is attached to the handle, and wherein the method further comprises:
rotating the plurality of needles or the powder distribution component about an axis of the cup portion to distribute the powder.
